(19) United States
(12) Patent Application Publication
(10) Pub. No.: US 2026/0075149 A1
(43) Pub. Date: Mar. 12, 2026

(54) IMAGE READING APPARATUS

(71) Applicant: SEIKO EPSON CORPORATION, TOKYO (JP)

(72) Inventors: Satoshi NAKATA, MATSUMOTO-SHI (JP); Masanari TANAKA, SHIOJIRI-SHI (JP); Yusuke KOMIYAMA, MATSUMOTO-SHI (JP); Kanji MOMOSE, MATSUMOTO-SHI (JP); Katsumi MARUYAMA, AZUMINO-SHI (JP); Masahito TATSUMI, SHIOJIRI-SHI (JP)

(21) Appl. No.: 19/244,036

(22) Filed: Jun. 20, 2025

(30) Foreign Application Priority Data
Jun. 21, 2024 (JP) 2024-100684

(51) Int. Cl. H04N 1/00; B41J 3/44

(52) U.S. Cl. CPC H04N 1/00615; B41J 3/44; H04N 2201/0081

(57) ABSTRACT

An image reading apparatus includes an enclosure; a placement section having a placement surface at which a medium is placed; a conveyer configured to convey the medium; a first guide that is displaceable between a first state and a second state, the first state being a state in which the first quide is located at a housed position where the first quide is housed in the enclosure above the placement section, the second state being a state in which the first quide is located at a supporting position where the first guide supports the medium; and an image reader configured to read an image from the medium conveyed by the conveyer, and the first guide in the second state inclines downward in a conveyance direction, and guides the conveyed medium to a position above an upstream end of the placement section or a position flush with the upstream end of the placement section.

The present application is based on, and claims priority from JP Application Serial Number 2024-100684, filed Jun. 21, 2024, the disclosure of which is hereby incorporated by reference herein in its entirety.

### BACKGROUND

### 1. Technical Field

The present disclosure relates to an image reading apparatus.

### 2. Related Art

There is a known image reading apparatus including a support that supports a medium, a placement section having a placement surface at which the medium supported by the support is placed, a conveyer that conveys the medium placed at the placement surface, an image reader that reads an image from the medium conveyed by the conveyer, a discharger that discharges the medium from which the image has been read by the image reader, and an enclosure that houses the support, the conveyer, the image reader, and the discharger, the image reading apparatus provided in an upper portion of a printing apparatus body (see JP-A-2023-167889).

JP-A-2023-167889 is an example of the related art.

In the image reading apparatus described in JP-A-2023-167889, the support is displaceable between a first state in which the support is housed in the enclosure and a second state in which the support supports the medium. In the image reading apparatus, the support in the second state is coupled to the placement surface of the placement section. In the image reading apparatus, however, when an operator attempts to place the medium at the placement surface while causing the medium to slide on the support in the second state, there is a concern that the medium comes into contact with an end portion of the placement surface so that the medium is deformed.

### SUMMARY

To solve the problem described above, an aspect of the present disclosure relates to an image reading apparatus attached to a printing apparatus and configured to read an image from a medium from which an image is to be read, the image reading apparatus including: an enclosure; a placement section having a placement surface at which the medium is placed; a conveyer configured to convey the medium in a predetermined conveyance direction; a first guide that is displaceable between a first state and a second state, the first state being a state in which the first guide is located at a housed position determined in advance as a position where the first quide is housed in the enclosure above the placement section, the second state being a state in which the first guide is located at a supporting position determined in advance as a position where the first guide cooperates with the placement section to support the medium; and an image reader configured to read an image from the medium conveyed by the conveyer, wherein the conveyance direction is, when viewed in a direction perpendicular to the placement surface, parallel to a direction in which the printing apparatus conveys a print medium, and
the first guide in the second state inclines downward from upstream to downstream in the conveyance direction, and guides the medium conveyed by the conveyer to a position above an upstream end of the placement section in the conveyance direction or a position flush with the upstream end of the placement section in the conveyance direction.

### BRIEF DESCRIPTION OF THE DRAWINGS

FIG. 1 is a perspective view showing an example of an exterior appearance of an image reading apparatus according to an embodiment, the exterior appearance including a front surface thereof.

FIG. 2 is a side cross-sectional view showing an example of the configuration of the image reading apparatus attached to a printing apparatus.

FIG. 3 is an enlarged view of the image reading apparatus shown in FIG. 1.

FIG. 4 is a cross-sectional view of the image reading apparatus shown in FIG. 3 so cut that exterior appearances of an engaging section and an engaged section can be seen.

FIG. 5 is a side cross-sectional view showing an example of the image reading apparatus with a first quide being in a second state.

FIG. 6 is a side cross-sectional view showing another example of the image reading apparatus with the first quide being in the second state.

FIG. 7 shows another example of the configuration of the first quide.

FIG. 8 shows another example of the engaging section in an enclosure.

FIG. 9 shows the first quide in a case where a first engaged section engages with a third engaging section.

FIG. 10 shows still another example of the configuration of the first guide.

FIG. 11 is an enlarged view of the first quide shown in FIG. 10.

FIG. 12 shows another example of the first guide in a first state.

FIG. 13 shows still another example of the configuration of the first guide.

FIG. 14 is a side cross-sectional view showing another example of the configuration image reading apparatus attached to the printing apparatus.

FIG. 15 shows an example of the configuration of a discharge tray in Variation 4 of the embodiment.

FIG. 16 is an enlarged view of the discharge tray in Variation 4 of the embodiment.

### DESCRIPTION OF EMBODIMENTS

### Embodiment

An embodiment of the present disclosure will be described below with reference to the drawings.

### Overview of Image Reading Apparatus According to Embodiment

An overview of an image reading apparatus according to the embodiment will first be described.

The image reading apparatus according to the embodiment is attached to a printing apparatus and reads an image from a medium from which an image is to be read. The image reading apparatus includes an enclosure, a placement section, a conveyer, a first guide, and an image reader. The placement section has a placement surface at which a medium is placed. The conveyer conveys the medium in a predetermined conveyance direction. The first guide is a member that is displaceable between a first state and a second state, the first state being a state in which the first guide is located at a housed position determined in advance as a position where the first guide is housed in the enclosure above the placement section, the second state being a state in which the first guide is located at a supporting position determined in advance as a position where the first guide cooperates with the placement section to support the medium. The image reader reads an image from the medium conveyed by the conveyer. The conveyance direction in the description is a direction parallel to the direction in which the printing apparatus conveys a print medium when viewed in the direction perpendicular to the placement surface. The first guide in the second state inclines downward as the first quide extends from upstream to downstream in the conveyance direction and guides the medium conveyed by the conveyer to a position above an upstream end of the placement section in the conveyance direction or a position flush with the upstream end of the placement section in the conveyance direction. The image reading apparatus can thus prevent deformation of the medium due to contact between the medium and the placement surface.

The configuration of the image reading apparatus according to the embodiment will be described below in detail.

### Configuration of Image Reading Apparatus According to Embodiment

The configuration of the image reading apparatus according to the embodiment will be described below with reference to an image reading apparatus 1 by way of example.

Note in the embodiment that a user of the image reading apparatus 1 is simply referred to as a user for convenience of description. In the present specification, a three-dimensional coordinate system TC is a three-dimensional orthogonal coordinate system indicating directions in a figure in which the three-dimensional coordinate system TC is drawn. In the following description, an X-axis in the three-dimensional coordinate system TC is simply referred to as X-axis for convenience of description. In the following description, a Y-axis in the three-dimensional coordinate system TC is simply referred to as Y-axis for convenience of description. In the following description, a Z-axis in the three-dimensional coordinate system TC is simply referred to as Z-axis for convenience of description. The following description will be made with reference to a case where the negative direction of the Z-axis coincides with the direction of gravity by way of example. Therefore, in the following description, the positive direction of the Z-axis is referred to as an upward direction or simply as upward, and the negative direction of the Z-axis is referred to as a downward direction or simply as downward for convenience of description. Furthermore, in the following description, the positive direction of the X-axis is referred to as a forward direction or simply as forward, and the negative direction of the X-axis is referred to as a rearward direction or simply as rearward for convenience of description.

Moreover, in the following description, a surface facing the positive side of the X-axis among the surfaces of the image reading apparatus 1 is referred to as a front surface of the image reading apparatus 1, and a surface facing the negative side of the X-axis among the surfaces of the image reading apparatus 1 is referred to as a rear surface of the image reading apparatus 1. Furthermore, in the following description, the phrase “when an object is viewed in a direction” is referred to as a phrase “when the object is viewed in the direction”.

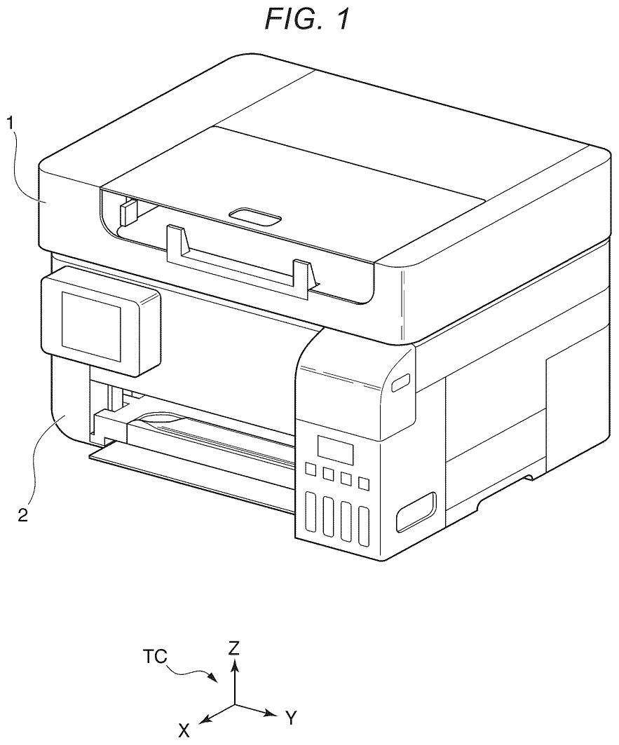

FIG. 1 is a perspective view showing an example of an exterior appearance of the image reading apparatus 1 according to the embodiment, the exterior appearance including the front surface thereof.

The image reading apparatus 1 is attached to a printing apparatus 2 and reads an image from a medium CP1, from which an image is to be read, as shown in FIG. 1. The printing apparatus 2 is, for example, an inkjet printer, but may instead be another type of printer. In the example shown in FIG. 1, when the printing apparatus 2 is viewed in the vertical direction, the printing apparatus 2 conveys a print medium in parallel to the X-axis and prints an image onto the conveyed print medium. The medium CP1 is, for example, a printed medium on which an image has been printed, but not necessarily. The following description will be made with reference to a case where the medium CP1 is an A4-size print sheet on which an image has been printed by way of example.

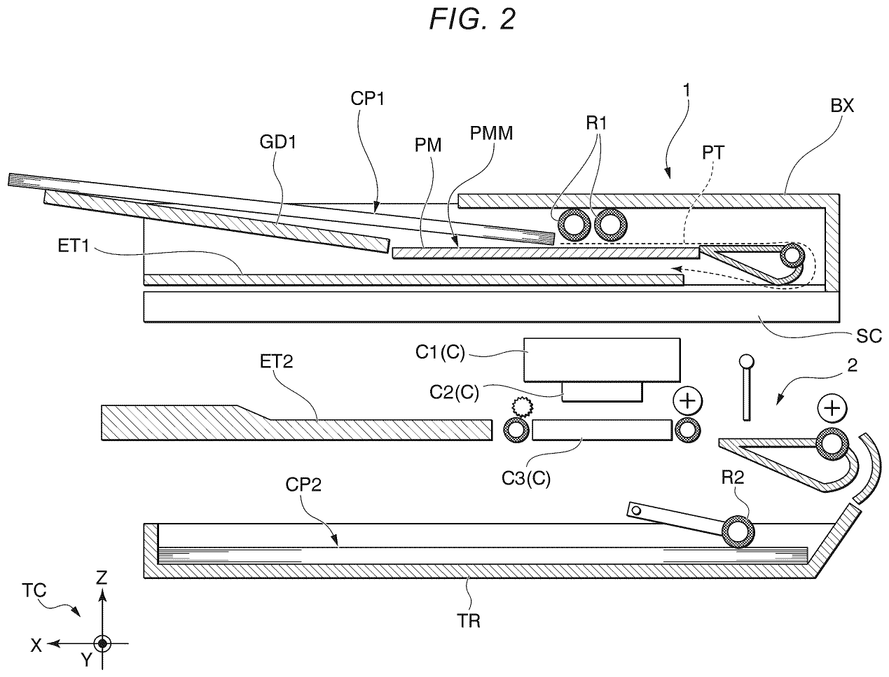

FIG. 2 is a side cross-sectional showing an example of the configuration of the image reading apparatus 1 attached to the printing apparatus 2. FIG. 2 is a side cross-sectional view of the image reading apparatus 1 and is also a side cross-sectional view showing an example of the configuration of the printing apparatus 2.

The image reading apparatus 1 includes an enclosure BX, a placement section PM, a conveyer R1, a first guide GD1, an image reader SC, and a discharge tray ET1, as shown in FIG. 2. Note that the image reading apparatus 1 may include other members in addition to the enclosure BX, the placement section PM, the conveyer R1, the first guide GD1, the image reader SC, and the discharge tray ET1.

The enclosure BX has a substantially box-like shape as a whole, and houses the members provided in the image reading apparatus 1. The enclosure BX therefore houses the placement section PM, the conveyer R1, the first guide GD1, the image reader SC, and the discharge tray ET1. Note that the enclosure BX may have another shape.

The placement section PM is a member having a placement surface PMM, at which one or more media CP1 are placed.

The conveyer R1 is a member that conveys the medium CP1 in a predetermined conveyance direction. In the example shown in FIG. 1, the conveyer R1 includes two separation rollers, and the two separation rollers convey the medium CP1 placed on the placement surface PMM of the placement section PM one at a time in the conveyance direction. Note that in place of the two separation rollers, the conveyer R1 may include another member capable of conveying the medium CP1 placed on the placement surface PMM of the placement section PM one at a time in the conveyance direction. In the following description, a downstream end of a certain object in the conveyance direction is referred to as the downstream end of the object, and an upstream end of the object in the conveyance direction is referred to as the upstream end of the object for convenience of description. The downstream end of the object is an end downstream in the conveyance direction out of the ends of the object. The upstream end of the object is an end upstream in the conveyance direction out of the ends of the object.

The conveyance direction in the description is parallel to the direction in which the printing apparatus 2 conveys a printed medium when viewed in the direction perpendicular to the placement surface PMM. In the example shown in FIG. 2, the direction perpendicular to the placement surface PMM is, for example, the vertical direction. Accordingly, in this case, the direction in which the printing apparatus 2 conveys a printed medium is a direction parallel to the X-axis, as described above. Therefore, in this case, the conveyance direction is also the direction parallel to the X-axis. However, the conveyance direction is not necessarily parallel to the X-axis, and may be a direction along the X-axis. A dotted line PT shown in FIG. 2 indicates a portion of the path along which the medium CP1 conveyed by the conveyer R1 passes. The conveyance direction may be a direction along the positive direction of the X-axis. Furthermore, the conveyance direction may be expressed as a direction along the negative direction of the X-axis. In this case, the conveyance direction is a direction in which the medium CP1 is conveyed along the negative direction of the X-axis in the path along which the medium CP1 conveyed by the conveyer R1 passes. In addition, in this case, the direction in which the medium CP1 is conveyed in the positive direction of the X-axis after passing through a portion where the medium CP1 is curved and caused to travel in the opposite direction in the path may be expressed as the opposite direction of the conveyance direction.

The first guide GD1 is a member that cooperates with the placement section PM to support the medium CP1. The first guide GD1 is a member that is displaceable between a first state and a second state, the first state being a state in which the first guide GD1 is located at a housed position determined in advance as a position where the first guide GD1 is housed in the enclosure BX above the placement surface PMM, the second state being a state in which the first guide GD1 is located at a supporting position determined in advance as a position where the first quide GD1 cooperates with the placement section PM to support the medium CP1. The state of the first guide GD1 shown in FIG. 2 is the second state. Therefore, in the example shown in FIG. 2, the first guide GD1 is coupled to the placement surface PMM of the placement section PM and cooperates with the placement section PM to support the medium CP1.

The image reader SC reads an image from the medium CP1 conveyed by the conveyer R1. That is, the image reader SC is a scanner.

The discharge tray ET1 is a tray to which the medium CP1 from which the image has been read by the image reader SC is discharged.

Meanwhile, the printing apparatus 2 includes a sheet feeding tray TR, a conveyer R2, a printing unit C, and a discharge tray ET2.

The sheet feeding tray TR is a tray in which media CP2 are placed as a print medium.

The conveyer R2 conveys a medium CP2 placed on the sheet feeding tray TR to the printing unit C. In this process, when the printing apparatus 2 is viewed in the vertical direction, the conveyer R2 conveys the medium CP2 in parallel to the X-axis to the printing unit C.

The printing unit C prints an image on the medium CP2 conveyed by the conveyer R2. The printing unit C includes, for example, a carriage C1, a printing head C2, and a platen C3.

The carriage C1 incorporates the printing head C2 and causes the printing head C2 to make reciprocating motion along a predetermined scanning direction. The scanning direction is a direction that intersects with the conveyance direction when viewed in the direction perpendicular to the placement surface PMM. In the example shown in FIG. 2, the scanning direction is a direction perpendicular to the conveyance direction in the view described above, that is, a direction parallel to the Y-axis. However, the scanning direction is not necessarily the direction parallel to the Y-axis, and may be a direction along the Y-axis.

The printing head C2 prints an image on the medium CP2 passing between the printing head C2 and the platen C3. In this example, the printing head C2 is, for example, an inkjet printing head, but is not limited thereto.

The platen C3 supports the medium CP2 conveyed by the conveyer R2 below the path along which the printing head C2 moves.

The discharge tray ET2 is a tray to which the medium CP2 on which the image has been printed by the printing unit C is discharged.

In the image reading apparatus 1 attached to the printing apparatus 2 having the configuration described above, the first quide GD1 inclines downward from upstream to downstream in the conveyance direction, and guides the medium CP1 conveyed by the conveyer R1 to a position above the upstream end of the placement section PM or a position flush with the upstream end of the placement section PM. The image reading apparatus 1 can thus prevent deformation of the medium CP1 due to contact between the medium CP1 and the placement surface PMM. The configurations of the first guide GD1 and surroundings around the first guide GD1 will be described below.

### Configurations of First Guide and Surroundings around First Guide

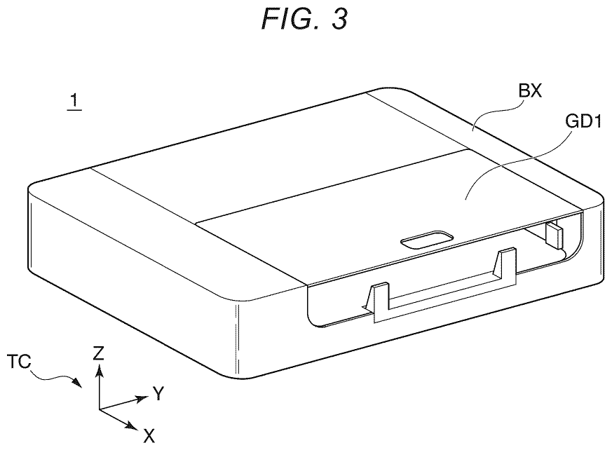

FIG. 3 is an enlarged view of the image reading apparatus 1 shown in FIG. 1. In the example shown in FIG. 3, the first guide GD1 is housed in the enclosure BX. That is, the state of the first guide GD1 shown in FIG. 3 is the first state. In other words, the position where the first quide GD1 shown in FIG. 3 is located is an example of the housed position. The first guide GD1 is displaceable between the first state and the second state by causing the first guide GD1 to slide with respect to the placement section PM in parallel to the conveyance direction when viewed in the direction perpendicular to the placement surface PMM. Accordingly, even when there is no empty space above the image reading apparatus 1, the user can change the state of the first guide GD1 between the first state and the second state. Note, however, that the first quide GD1 may be displaceable between the first state and the second state by causing the first guide GD1 to slide with respect to the placement section PM in a direction along the conveyance direction. Since the first quide GD1 is displaceable between the first state and the second state as described above, the enclosure BX includes an engaging section EG1, which engages with the first guide GD1. The first guide GD1 includes an engaged section EG2, which engages with the engaging section EG1, and can be pulled out from the enclosure BX in a predetermined pullout direction. In the example shown in FIG. 3, the pullout direction is a direction in which the first guide GD1 in the first state slides with respect to the enclosure BX. The following description will be made with reference to a case where the pullout direction coincides with the positive direction of the X-axis. The enclosure BX may include a single engaging section EG1, or may include two or more engaging sections EG1. The number of the engaged sections EG2, which engage with the engaging section EG1, is equal to the number of the engaging sections EG1.

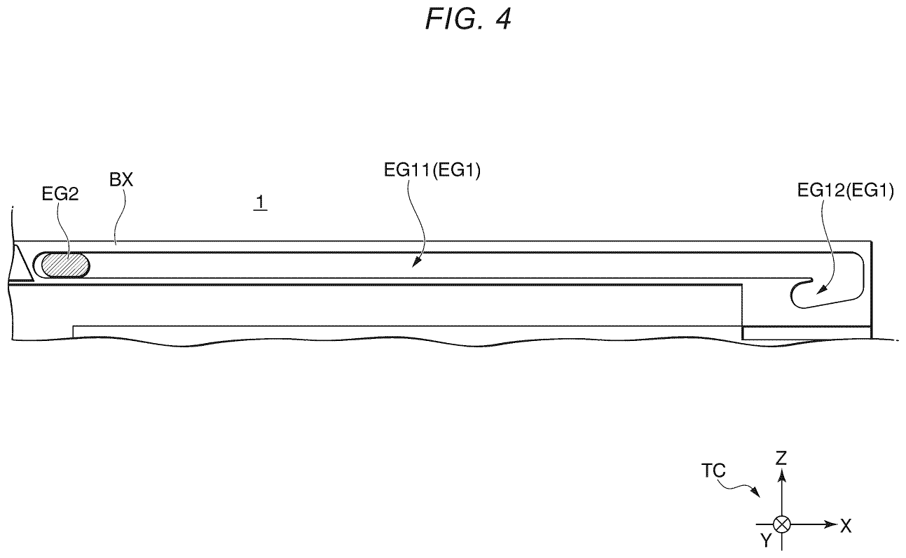

FIG. 4 is a cross-sectional view of the image reading apparatus 1 shown in FIG. 3 so cut that the exterior appearance of the engaging section EG1 and the engaged section EG2 can be seen. In the example shown in FIG. 4, the engaging section EG1 is provided at each of two inner walls that intersect with the Y-axis out of the inner walls of the enclosure BX. That is, in this example, the enclosure BX includes two engaging sections EG1. The two engaging sections EG1 face each other in the direction parallel to the Y-axis and have the same configuration. The following description will therefore be made with reference to a case where the configuration of the engaging section EG1 on the positive side of the Y-axis out of the two engaging sections EG1 as an example of the configuration of the two engaging sections EG1. Note that when the enclosure BX includes the two engaging sections EG1, the engaged sections EG2, which engage with the engaging sections EG1, are provided at opposite end portions in the direction parallel to the Y-axis out of the end portions of the first guide GD1. That is, in this case, the first guide GD1 includes two engaged sections EG2.

The engaging sections EG1 each include a first engaging section EG11, with which the engaged section EG2 of the first guide GD1 in the first state engages, and a second engaging section EG12, with which the engaged section EG2 of the first guide GD1 in the second state engages. In this example, the pullout direction coincides with the positive direction of the X-axis, as described above. Therefore, the first engaging sections EG11 are located above the placement surface PMM and extend in a direction parallel to the pullout direction. In the example shown in FIG. 4, the engaged sections EG2 engage with the first engaging sections EG11 at the downstream end of the first engaging sections EG11. In the example shown in FIG. 4, the second engaging sections EG12 each extend from the downstream end of the first engaging section EG11 downward from the first engaging section EG11 and downstream from the first engaging section EG11 in the conveyance direction. In other words, the second engaged sections EG12 each incline downward from the upstream end of the first engaging section EG11 and downstream from the first engaging section EG11 in the conveyance direction.

The user can displace the first guide GD1 from the first state to the second state by causing the first guide GD1 shown in FIG. 4 to slide with respect to the enclosure BX in the pullout direction to cause the engaged sections EG2 to engage with the second engaging sections EG12. The length of the image reading apparatus 1 in the pullout direction and the length of the image reading apparatus 1 in the width direction perpendicular to each of the pullout direction and the vertical direction can thus be shortened, resulting in reduction in size of the image reading apparatus 1.

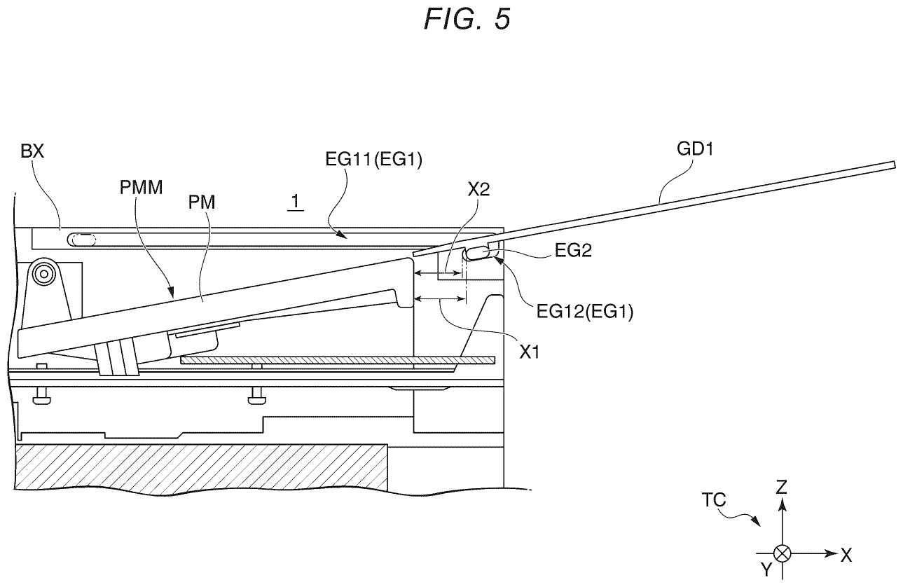

FIG. 5 is a side cross-sectional view showing an example of the image reading apparatus 1 with the first guide GD1 being in the second state. FIG. 5 shows the engaged section EG2 on the negative side of the Y-axis out of the engaged sections EG2 with which the first guide GD1 is provided. FIG. 5 does not show the engaged section EG2 on the positive side of the Y-axis out of the engaged sections EG2 with which the first guide GD1 is provided because the invisible engaged section EG2 is hidden behind the body of the first guide GD1. The hidden engaged section EG2 engages with the second engaging section EG12 on the positive side of the Y-axis out of the second engaging sections EG12 provided in the enclosure BX. The hidden engaged section EG2 is located at the downstream end of the second engaging section EG12. In this case, the engaged section EG2 on the negative side of the Y-axis out of the engaged sections EG2 with which the first guide GD1 is provided engages with the second engaging section EG12 on the negative side of the Y-axis out of the second engaging sections EG12 provided in the enclosure BX. The state of the first guide GD1 shown in FIG. 5 is therefore the second state.

In the example shown in FIG. 5, a portion of the second engaging sections EG12 overlaps with the placement surface PMM when the second engaging sections EG12 are viewed in the direction parallel to the pullout direction. Accordingly, in the image reading apparatus 1, the length of the enclosure BX in the vertical direction can be shortened and the size of the image reading apparatus 1 can therefore be reduced as compared with a case where none of the second engaging sections EG12 overlaps with the placement surface PMM in the view described above. Note that the image reading apparatus 1 may be so configured that the entire second engaging sections EG12 overlap with the placement surface PMM when the second engaging sections EG12 are viewed in the direction parallel to the pullout direction. In this case, in the image reading apparatus 1, the length of the enclosure BX in the vertical direction can be shortened more reliably as compared with the case where none of the second engaging sections EG12 overlaps with the placement surface PMM in the view described above. Furthermore, the image reading apparatus 1 may be so configured that none of the second engaging sections EG12 overlaps with the placement surface PMM when the second engaging sections EG12 are viewed in the direction parallel to the pullout direction. In this case, although the image reading apparatus 1 cannot be reduced in size, the upper surface of the first guide GD1 in the second state is allowed to incline more steeply. The configuration described above is useful because it reduces the length of the image reading apparatus 1 in the frontward-rearward direction when the first guide GD1 is in the second state.

Furthermore, the downstream end of the first guide GD1 in the second state is above the upstream end of the placement section PM or flush with the upstream end of the placement section PM. In the example shown in FIG. 5, the downstream end of the first guide GD1 in the second state is above the upstream end of the placement section PM. The image reading apparatus 1 can thus prevent deformation of the medium CP1 due to the contact between the medium CP1 and the placement surface PMM. This is because the medium CP1 caused to slide along the upper surface of the first guide GD1 from a position higher than or flush with the upstream end of the placement section PM and placed on the placement surface PMM does not come into contact with the upstream end of the placement section PM in a direction parallel to the upper surface of the first guide GD1.

In the example shown in FIG. 5, a distance X1 in the conveyance direction between the downstream end of each of the engaged sections EG2 and the downstream end of the first guide GD1 is greater than or equal to a distance X2 in the conveyance direction between the downstream end of each of the second engaging sections EG12 and the upstream end of the placement section PM. The image reading apparatus 1 can thus prevent formation of a gap between the downstream end of the first guide GD1 in the second state and the upstream end of the placement section PM. The configuration described above is useful because it prevents the medium CP1 from entering the gap between the downstream end of the first guide GD1 in the second state and the upstream end of the placement section PM. The image reading apparatus 1 can thus more reliably prevent deformation of the medium CP1 due to the contact between the medium CP1 and the placement surface PMM.

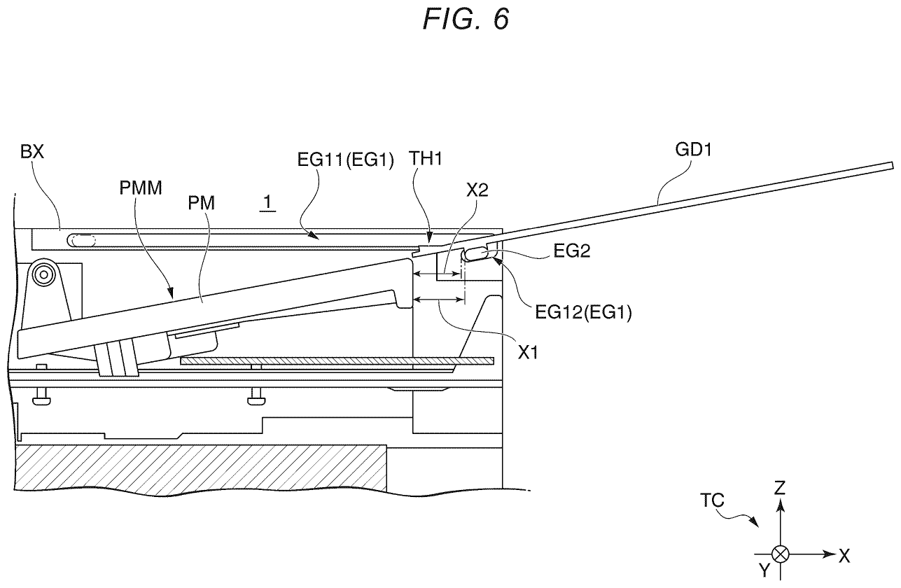

Note that the first guide GD1 may include a protrusion TH1, as shown in FIG. 6. FIG. 6 is a side cross-sectional view showing another example of the image reading apparatus 1 with the first guide GD1 being in the second state.

The protrusion TH1 is located downstream from the center of the first guide GD1 in the conveyance direction, protrudes upward from the first guide GD1, and guides the medium CP1 conveyed by the conveyer R1 to a position above the upstream end of the placement section PM or to a position flush with the upstream end of the placement section PM. In the example shown in FIG. 6, an uppermost portion of the protrusion TH1 is higher than the downstream end of the first guide GD1 located at a position higher than the upstream end of the placement section PM. Therefore, in this example, the image reading apparatus 1 more reliably quides the medium CP1 conveyed by the conveyer R1 to a position above the upstream end of the placement section PM. As a result, the image reading apparatus 1 can more reliably prevent deformation of the medium CP1 due to the contact between the medium CP1 and the placement surface PMM. When the first quide GD1 includes the protrusion TH1, the image reading apparatus 1 can guide the medium CP1 conveyed by the conveyer R1 to a position above the upstream end of the placement section PM or a position flush with the upstream end of the placement section PM irrespective of the inclination angle of the upper surface of the first guide GD1 in the second state and irrespective of the height of the downstream end of the first guide GD1. As a result, the image reading apparatus 1 can prevent failure in conveyance of the medium CP1, an error of reading an image from the medium CP1, and the like.

As described above, the image reading apparatus 1 guides the medium CP1 conveyed by the conveyer R1 to a position above the upstream end of the placement section PM or a position flush with the upstream end of the placement section PM with the aid of the first quide GD1 in the second state. The image reading apparatus 1 can thus prevent deformation of the medium CP1 due to the contact between the medium CP1 and the placement surface PMM.

### Variation 1 of Embodiment

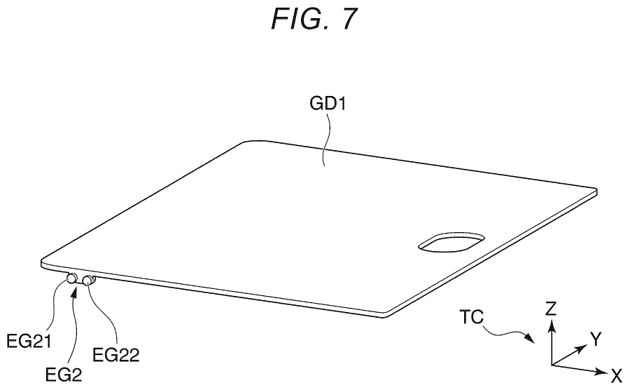

A variation 1 of the embodiment will be described below. In Variation 1 of the embodiment, the engaged sections EG2 of the first guide GD1 each include a first engaged section EG21 and a second engaged section EG22 arranged in parallel to the conveyance direction when the first guide GD1 is in the first state. FIG. 7 shows another example of the configuration of the first guide GD1. In the example shown in FIG. 7, the first engaged section EG21 is located downstream from the second engaged section EG22 in the conveyance direction when viewed in the direction perpendicular to the placement surface PMM. The first engaged section EG21 and the second engaged section EG22 are cylindrical protrusions protruding from the first guide GD1 in the direction perpendicular to the conveyance direction. In this example, the first engaged section EG21 is separate from the second engaged section EG22. The first engaged section EG21 may instead be coupled to the second engaged section EG22. FIG. 7 does not show the engaged section EG2 on the positive side of the Y-axis out of the engaged sections EG2 with which the first guide GD1 is provided because the invisible engaged section EG2 is hidden behind the body of the first guide GD1.

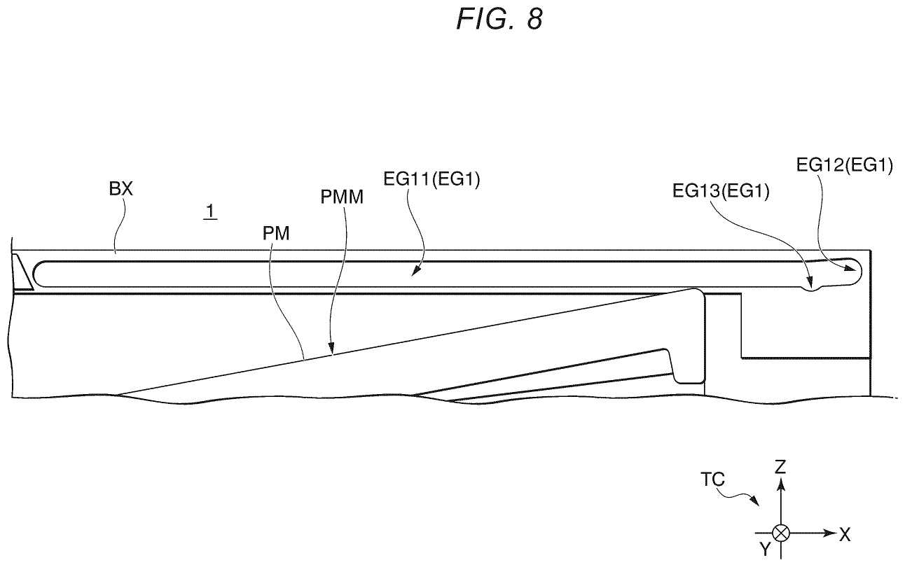

When the engaged sections EG2 each include the first engaged section EG21 and the second engaged section EG22, the first engaging sections EG11 and the second engaging sections EG12 are configured, for example, as shown in FIG. 8. FIG. 8 shows another example of the engaging sections EG1 in the enclosure BX. In Variation 1 of the embodiment, the first engaging sections EG11 are each located above the placement surface PMM and extends in the direction parallel to the pullout direction, as shown in FIG. 8. In Variation 1 of the embodiment, the second engaging sections EG12 are each the upstream end of the first engaging section EG11 and engages with the second engaged section EG22 of the first guide GD1 in the second state. In Variation 1 of the embodiment, the engaging sections EG1 each include a third engaging section EG13, which engages with the first engaged section EG21 when the second engaging section EG12 engages with the second engaged section EG22 as well as the first engaging section EG11, the second engaging section EG12. The third engaging section EG13 is located below the second engaging section EG12 and downstream from the second engaging section EG12 in the conveyance direction. More specifically, the third engaging section EG13 is a recess formed downward from the first engaging section EG11. Therefore, when the third engaging section EG13 engages with the first engaged section EG21, the first engaged section EG21 is caught by the third engaging section EG13, so that the first guide GD1 does not slide in the conveyance direction due to gravity.

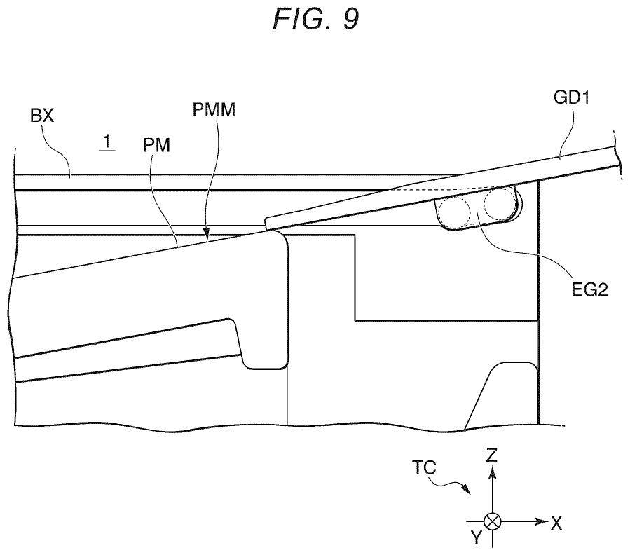

FIG. 9 shows the first guide GD1 in the case where the first engaged section EG21 engages with the third engaging section EG13. In the example shown in FIG. 9, the first engaged section EG21 engages with the third engaging section EG13. In this example, the second engaged section EG22 engages with the second engaging section EG12. The upper surface of the first guide GD1 therefore inclines as the upper surface of the first guide GD1 shown in FIG. 5. Even in this case, the downstream end of the first quide GD1 in the second state can be above the upstream end of the placement section PM or flush with the upstream end of the placement section PM. In the example shown in FIG. 9, the downstream end of the first guide GD1 in the second state is above the upstream end of the placement section PM. The image reading apparatus 1 can therefore prevent deformation of the medium CP1 due to the contact between the medium CP1 and the placement surface PMM also in Variation 1 of the embodiment.

Note in the embodiment and Variation 1 of the embodiment that the user can set the second state of the first guide GD1 only by pulling out the first quide GD1 substantially in the pullout direction. Therefore, in Variation 1 of the embodiment, even when there is no empty space above the image reading apparatus 1, the state of the first guide GD1 can be changed from the first state to the second state. Furthermore, in Variation 1 of the embodiment, since the difference between the height of the first engaging section EG11 and the second engaging section EG12 and the height of the third engaging section EG13 can be reduced, the length of the image reading apparatus 1. in the vertical direction can be reduced, resulting in reduction in size of the image reading apparatus 1.

### Variation 2 of Embodiment

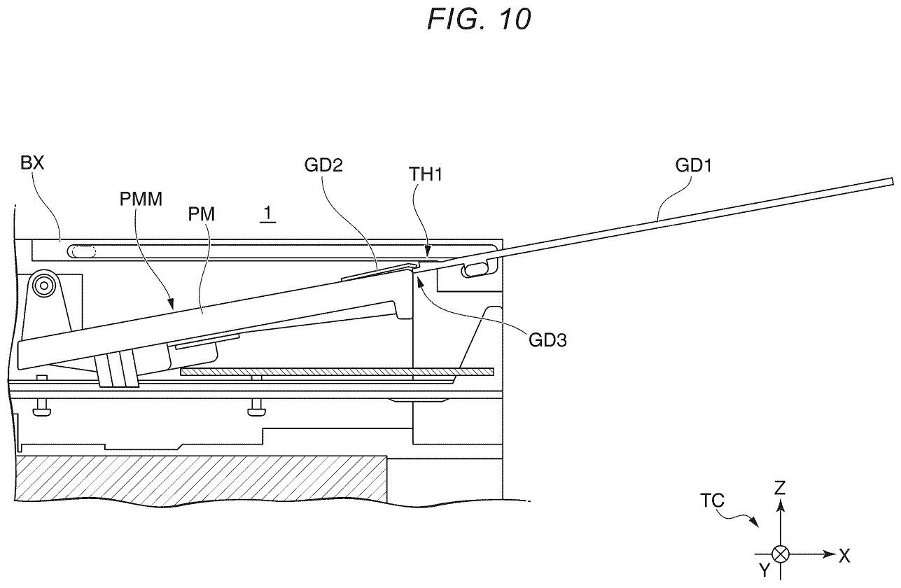

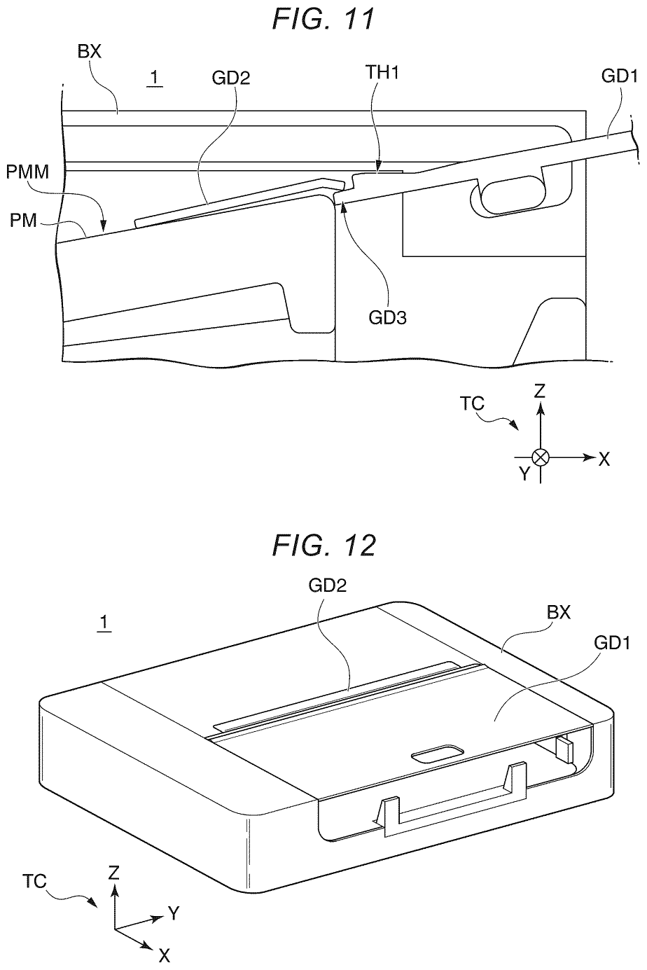

Variation 2 of the embodiment will be described below. In Variation 2 of the embodiment, a second quide GD2 is provided at the downstream end of the first guide GD1, and guides the medium CP1 guided by the first guide GD1 in the second state toward a position above the placement section PM and downstream from the downstream end of the first guide GD1 in the conveyance direction. FIG. 10 shows still another example of the configuration of the first guide GD1. FIG. 11 is an enlarged view of the first quide GD1 shown in FIG. 10.

The first quide GD1 shown in FIGS. 10 and 11 includes the protrusion TH1 as the first quide GD1 shown in FIG. 6. When the first quide GD1 is in the second state, the uppermost end of the protrusion TH1 is above the uppermost end of the second guide GD2 or flush with the uppermost end of the second guide GD2. In the example shown in FIGS. 10 and 11, when the first quide GD1 is in the second state, the uppermost end of the protrusion TH1 is above the uppermost end of the second guide GD2.

The first guide GD1 shown in FIGS. 10 and 11 includes a third guide GD3 located downstream from the protrusion TH1 in the conveyance direction and extending in a direction in which the first guide GD1 extends. The downstream end of the third guide GD3 is above the upstream end of the placement section PM or flush with the upstream end of the placement section PM. In the example shown in FIGS. 10 and 11, the downstream end of the third guide GD3 is flush with the upstream end of the placement section PM. The first guide GD1 includes the protrusion TH1 and the third quide GD3. Therefore, even when the front end of the medium CP1 guided by the protrusion TH1 falls into a gap between the placement section PM and the protrusion TH1 for some reason, the image reading apparatus 1 can prevent contact between the upstream end of the placement section PM and the medium CP1. As a result, the image reading apparatus 1 can more reliably prevent deformation of the medium CP1 due to the contact between the medium CP1 and the placement surface PMM.

The second guide GD2 is provided at the downstream end of the first quide GD1 shown in FIGS. 10 and 11, and quides the medium CP1 guided by the first guide GD1 in the second state toward a position downstream in the conveyance direction from the downstream end of the first guide GD1 above the placement section PM. More specifically, the second quide GD2 is a substantially planar-plate-shaped member extending from the upper surface of the third guide GD3 in parallel to the upper surface toward a position downstream in the conveyance direction. The second guide GD2 therefore covers the upstream end of the placement section PM when the first guide GD1 is in the second state. In other words, at least a portion of the second guide GD2 is located on the placement surface PMM when the first quide GD1 is in the second state. The image reading apparatus 1 can thus prevent the contact between the upstream end of the placement section PM and the medium CP1. As a result, the image reading apparatus 1 can more reliably prevent deformation of the medium CP1 due to the contact between the medium CP1 and the placement surface PMM. The configuration of the image reading apparatus 1 is useful for preventing problems therewith, such as failure in conveyance of the medium CP1, and an error of reading an image from the medium CP1. Furthermore, since at least a portion of the second guide GD2 covers an upper end portion of the placement section PM, the image reading apparatus 1 allows improvement in the degree of freedom in designing the shape of the upper end portion of the placement section PM. The reason for the improvement described above is that the front end of the medium CP1 guided by the first guide GD1 in the second state does not come into contact with the upper end portion of the placement section PM irrespective of the shape of the upper end portion of the placement section PM below the second guide GD2.

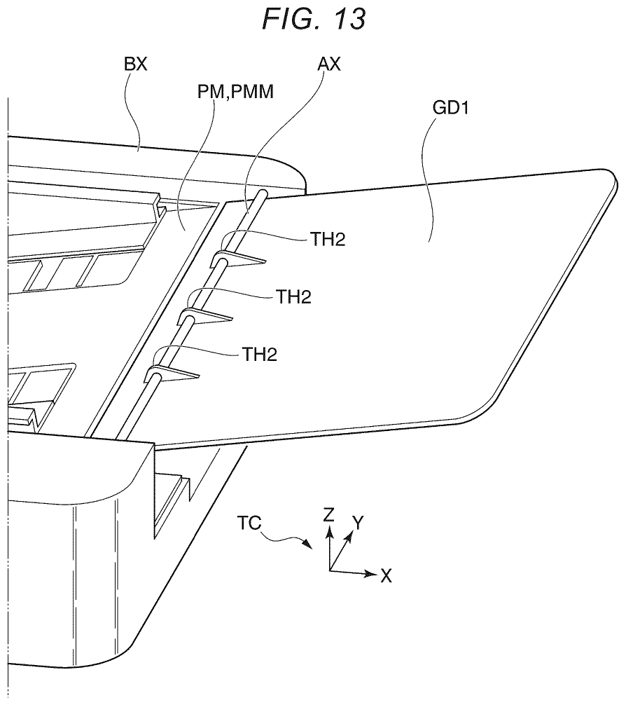

FIG. 12 shows another example of the first guide GD1 in the first state. At least a portion of the second guide GD2 is located on the upper surface of the enclosure BX when the first guide GD1 is in the first state, as shown in FIG. 12. The upper surface of the second quide GD2 is therefore higher than the upper surface of the first guide GD1 in the state described above. Accordingly, when the first guide GD1 is in the first state, the image reading apparatus 1 can suppress accumulation of dust or the like on the placement surface PMM.

As described above, since the first guide GD1 includes the second guide GD2, the image reading apparatus 1 can prevent deformation of the medium CP1 due to the contact between the medium CP1 and the placement surface PMM.

### Variation 3 of Embodiment

Variation 3 of the embodiment will be described below. In Variation 3 of the embodiment, in place of the configuration in which the first quide GD1 is caused to slide with respect to the enclosure BX so as to be displaced between the first state and the second state, the first quide GD1 is configured to rotate with respect to the enclosure BX so as to be displaced between the first state and the second state. FIG. 13 shows still another example of the configuration of the first guide GD1.

The first guide GD1 is provided in the enclosure BX so as to be rotatable around a axis of rotation AX determined in advance with respect to the placement surface PMM, and rotated around the axis of rotation AX so as to be displaced between the first state and the second state. The axis of rotation AX intersects with the conveyance direction. In the example shown in FIG. 13, since the axis of rotation AX is perpendicular to the conveyance direction, the axis of rotation AX is an axis parallel to the Y-axis. The user can displace the first quide GD1 from the first state to the second state by manually pulling out the first guide GD1 in the first state toward the front upper side to rotate the first guide GD1 with respect to the enclosure BX. Accordingly, the image reading apparatus 1 can prevent dust, dirt, and the like accumulated on the upper surface of the first quide GD1 from falling onto the placement surface PMM during a period for which the image reading apparatus 1 is not used.

The first guide GD1 includes one or more second protrusions TH2 protruding upward from the axis of rotation AX. In the example shown in FIG. 13, the first quide GD1 has three second protrusions TH2. The three second protrusions TH2 each guide the medium CP1, which is guided by the first guide GD1 in the second state, to a position downstream in the conveyance direction from the downstream end of the first guide GD1 above the placement section PM. The image reading apparatus 1 can thus guide the medium CP1 conveyed by the conveyer R1 to a position above the upstream end of the placement section PM or a position flush with the upstream end of the placement section PM irrespective of the position of the axis of rotation AX. As a result, the image reading apparatus 1 can more reliably prevent deformation of the medium CP1 due to the contact between the medium CP1 and the placement surface PMM.

As described above, even with the configuration in which the first guide GD1 rotates with respect to the enclosure BX so as to be displaced between the first state and the second state, the image reading apparatus 1 Can prevent deformation of the medium CP1 due to the contact between the medium CP1 and the placement surface PMM.

### Variation 4 of embodiment

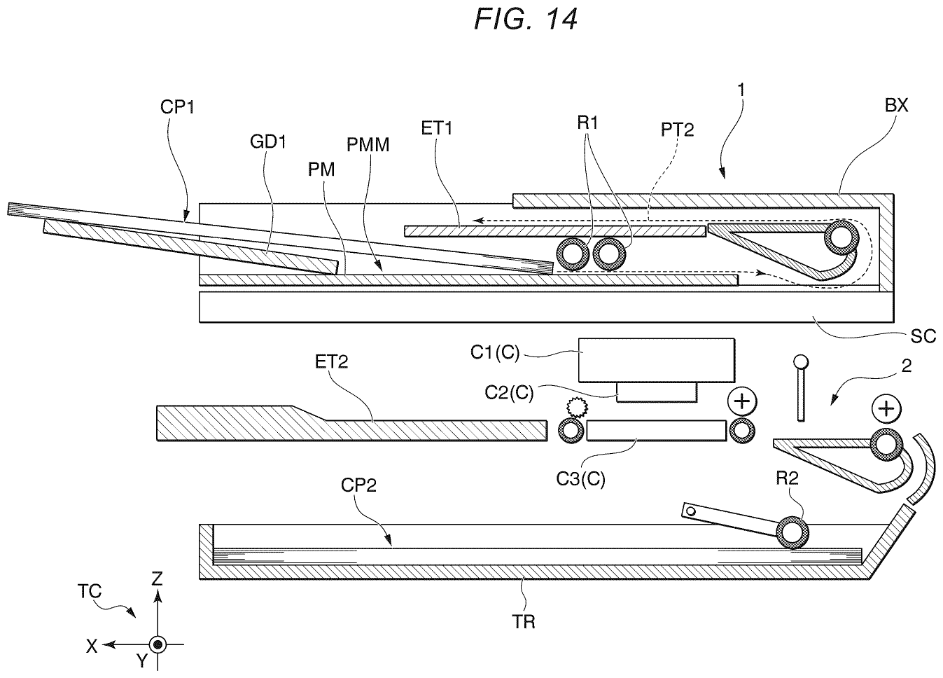

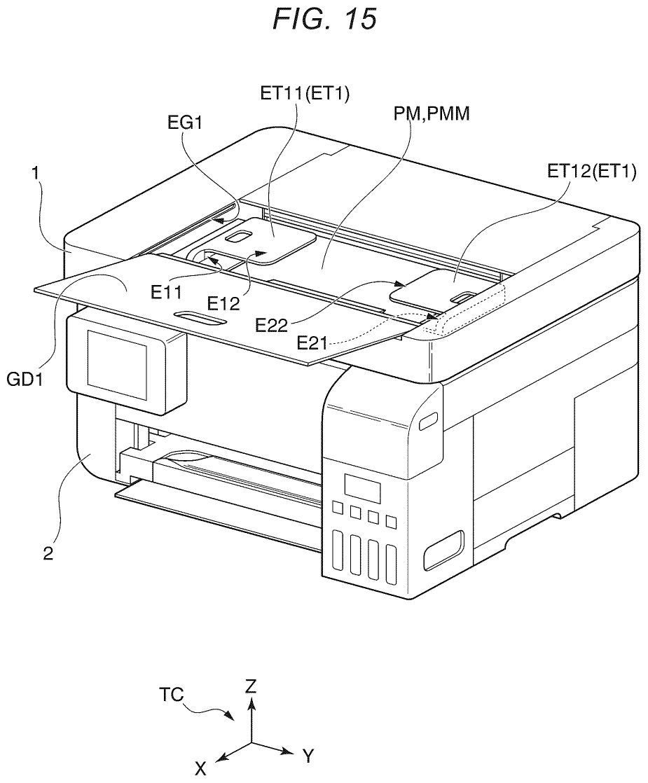

Variation 4 of the embodiment will be described below. In Variation 4 of the embodiment, the discharge tray ET1 of the image reading apparatus 1 is located above the placement surface PMM. FIG. 14 is a side cross-sectional view showing another example of the configuration of the image reading apparatus 1 attached to the printing apparatus 2. FIG. 14 is a side cross-sectional view of the image reading apparatus 1 and is also a side cross-sectional view showing an example of the configuration of the printing apparatus 2.

A dotted line PT2 shown in FIG. 14 indicates a portion of the path along which the medium CP1 conveyed by the conveyer R1 passes. The conveyer R1 conveys the medium CP1 supported by each of the first guide GD1 in the second state and the placement surface PMM along the dotted line PT2 below the discharge tray ET1. The image reader SC reads an image from the medium CP1 thus conveyed by the conveyer R1. The medium CP1 from which the image has been read by the image reader SC is discharged to the discharge tray ET1 located above the placement surface PMM. In this case, the entire first quide GD1 is located above the placement surface PMM in both the first state and the second state. The image reading apparatus 1 can therefore more reliably prevent deformation of the medium CP1 due to the contact between the medium CP1 and the placement surface PMM. Furthermore, in this case, since the medium CP1 on the discharge tray ET1 is readily visible when the image reading apparatus 1 is viewed in the direction of gravity, the image reading apparatus 1 allows the user to readily visually recognize whether the image has been read from the medium CP1.

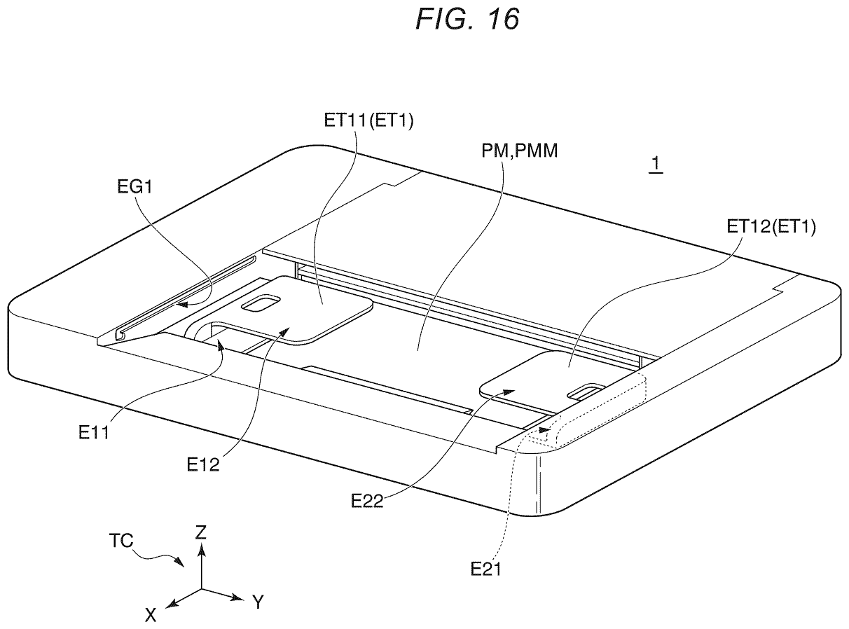

When the discharge tray ET1 is located above the placement surface PMM, the discharge tray ET1 may have an eave-shaped structure as shown in FIG. 15, FIG. 15 shows an example of the configuration of the discharge tray ET1 according to Variation 4 of the embodiment. In FIG. 15, the state of the first guide GD1 is the second state. FIG. 16 is an enlarged view of the discharge tray ET1 in Variation 4 of the embodiment.

In the example shown in FIGS. 15 and 16, the discharge tray ET1 includes a first medium support ET11 and a second medium support ET12 different from the first medium support ET11. The first medium support ET11 and the second medium support ET12 are disposed so as to be separate from each other in such a way that the distance between the first medium support ET11 and the second medium support ET12 in an intersecting direction is a predetermined distance. In this example, the intersecting direction is the direction perpendicular to the conveyance direction, that is, the direction parallel to the Y-axis. The predetermined distance is, for example, about 10 centimeters, but is not limited thereto.

The first medium support ET11 includes an eleventh portion E11 extending upward from the end on the negative side of the Y-axis out of the ends of the placement surface PMM, and a planar-plate-shaped twelfth portion E12 extending in the positive direction of the Y-axis from the eleventh portion E11 at a position above the placement surface PMM by a predetermined height. Therefore, the first medium support ET11 is an eave-shaped member that covers a portion of the placement surface PMM when the image reading apparatus 1 is viewed in the direction of gravity and creates a gap between the twelfth portion E12 and the placement surface PMM.

Meanwhile, the second medium support ET12 includes a twenty-first portion E21 extending upward from the end on the positive side of the Y-axis out of the ends of the placement surface PMM, and a planar-plate-shaped twenty-second portion E22 extending in the negative direction of the Y-axis from the twenty-first portion E21 at a position above the placement surface PMM by a predetermined height. Therefore, the second medium support ET12 is an eave-shaped member that covers a portion of the placement surface PMM when the image reading apparatus 1 is viewed in the direction of gravity and creates a gap between the twenty-second portion E22 and the placement surface PMM.

As described above, when the discharge tray ET1 includes the first medium support ET11 and the second medium support ET12, the upper surface of the discharge tray ET1 is configured with the upper surface of the twelfth portion E12 and the upper surface of the twenty-second portion E22. The image reading apparatus 1 therefore discharges the medium CP1 from which an image has been read by the image reader SC onto the upper surface of the discharge tray ET1 configured with the upper surface of the twelfth portion E12 and the upper surface of the twenty-second portion E22. In this case, the user can lift the medium CP1 by inserting a finger from at least one of the gap between the placement surface PMM and the twelfth portion E12 and the gap between the placement surface PMM and the twenty-second portion E22, resulting in improvement in the usability of the image reading apparatus 1.

When the discharge tray ET1 includes the first medium support ET11 and the second medium support ET12, the engaging sections EG1 provided in the enclosure BX are located above the first medium support ET11 and the second medium support ET12, as shown in FIGS. 15 and 16. This is because the first guide GD1 in the first state is located above the discharge tray ET1. The image reading apparatus 1 can therefore prevent deformation of the placement surface PMM, the discharge tray ET1, and other elements due, for example, to a fallen object during a period for which the image reading apparatus 1 is not used.

Note in the image reading apparatus 1 described above that when the first guide GD1 is in the first state, the upper surface of the first quide GD1 may be contained in an imaginary plane containing the upper surface of the enclosure BX. In this case, the image reading apparatus 1 can prevent the user's finger from hitting a step between the first guide GD1 and the enclosure BX when the user operates the first guide GD1 in a situation in which the space above the image reading apparatus 1 is narrow. In this case, the step is not created in the image reading apparatus 1. The image reading apparatus 1 can therefore prevent the exterior appearance from deteriorating due to the step.

The items described above may be combined with each other in any way.

### Additional Remarks

[1]

An image reading apparatus attached to a printing apparatus and configured to read an image from a medium from which an image is to be read, the image reading apparatus including an enclosure; a placement section having a placement surface at which the medium is placed; a conveyer configured to convey the medium in a predetermined conveyance direction; a first guide that is displaceable between a first state and a second state, the first state being a state in which the first quide is located at a housed position determined in advance as a position where the first guide is housed in the enclosure above the placement section, the second state being a state in which the first quide is located at a supporting position determined in advance as a position where the first guide cooperates with the placement section to support the medium; and an image reader configured to read an image from the medium conveyed by the conveyer, the conveyance direction being, when viewed in a direction perpendicular to the placement surface, parallel to a direction in which the printing apparatus conveys a print medium, the first guide in the second state inclining downward from upstream to downstream in the conveyance direction, and guiding the medium conveyed by the conveyer to a position above an upstream end of the placement section in the conveyance direction or a position flush with the upstream end of the placement section in the conveyance direction.
[2]

The image reading apparatus according to [1], wherein the first guide slides with respect to the placement section in parallel to the conveyance direction when viewed in the direction perpendicular to the placement surface so as to be displaceable between the first state and the second state.
[3]

The image reading apparatus according to [2], wherein the enclosure includes an engaging section configured to engage with the first guide, the first guide includes an engaged section configured to engage with the engaging section, and is allowed to be pulled out of the enclosure in a predetermined pullout direction, the pullout direction is a direction parallel to the conveyance direction when viewed in the direction perpendicular to the placement surface, and the engaging section includes a first engaging section with which the engaged section of the first quide in the first state engages, and a second engaging section with which the engaged section of the first guide in the second state engages.
[4]

The image reading apparatus according to [3], wherein the first engaging section is located above the placement surface and extends in a direction parallel to the pullout direction, and the second engaging section extends from an upstream end of the first engaging section in the conveyance direction toward a position below the first engaging section and downstream in the conveyance direction from the first engaging section.
[5]

The image reading apparatus according to [4], wherein at least a portion of the second engaging section overlaps with the placement surface when viewed in the direction parallel to the pullout direction.
[6]

The image reading apparatus according to [3], wherein the engaged section includes a first engaged section and a second engaged section arranged in parallel to the conveyance direction when the first guide is in the first state, the first engaged section is located downstream in the conveyance direction from the second engaged section when viewed in the direction perpendicular to the placement surface, the first engaging section is located above the placement surface and extends in a direction parallel to the pullout direction, the second engaging section is an upstream end of the first engaging section in the conveyance direction and is configured to engage with the second engaged section of the first quide in the second state, the engaging section includes a third engaging section configured to engage with the first engaged section when the second engaging section engages with the second engaged section, and the third engaging section is located below the second engaging section and downstream in the conveyance direction from the second engaging section.
[7]

The image reading apparatus according to [6], wherein a distance in the conveyance direction between a downstream end of the engaged section in the conveyance direction and a downstream end of the first guide in the conveyance direction is greater than or equal to a distance in the conveyance direction between a downstream end of the second engaging section in the conveyance direction and the upstream end of the placement section in the conveyance direction.
[8]

The image reading apparatus according to any one of [1] to [7], wherein the first guide includes a protrusion located downstream in the conveyance direction from a center of the first guide and protruding upward from the first guide, and the protrusion is configured to guide the medium conveyed by the conveyer to the position above the upstream end of the placement section in the conveyance direction or the position flush with the upstream end of the placement section in the conveyance direction.
[9]

The image reading apparatus according to any one of [1] to [8], wherein a second guide configured to guide the medium is provided above the placement section and at the downstream end of the first guide in the conveyance direction, and the second quide is configured to guide the medium guided by the first guide in the second state toward a position downstream in the conveyance direction from the downstream end of the first guide in the conveyance direction.
[10]

The image reading apparatus according to [9], wherein at least a portion of the second guide is located on an upper surface of the enclosure when the first guide is in the first state, and is located on the placement surface when the first guide is in the second state.
[11]

The image reading apparatus according to any one of [1] to [10], wherein the first guide includes the protrusion located downstream in the conveyance direction from the center of the first guide and protruding upward from the first guide, the protrusion is configured to guide the medium conveyed by the conveyer to the position above the upstream end of the placement section in the conveyance direction or the position flush with the upstream end of the placement section in the conveyance direction, the second guide configured to guide the medium is provided above the placement section and at the downstream end of the first guide in the conveyance direction, the second guide is configured to guide the medium guided by the first guide in the second state toward the position downstream in the conveyance direction from the downstream end of the first guide in the conveyance direction, and when the first quide is in the second state, an uppermost end of the protrusion is above an uppermost end of the second quide or flush with the uppermost end of the second guide.
[12]

The image reading apparatus according to any one of [1] to [11], wherein the first guide includes the protrusion located downstream in the conveyance direction from the center of the first quide and protruding upward from the first guide, and a third guide located downstream in the conveyance direction from the protrusion and extending in a direction in which the first quide extends, the protrusion is configured to quide the medium conveyed by the conveyer to the position above the upstream end of the placements section in the conveyance direction or the position flush with the upstream end of the placement section in the conveyance direction, and a downstream end of the third quide in the conveyance direction is above the upstream end of the placement section in the conveyance direction or flush with the upstream end of the placement section.
[13]

The image reading apparatus according to any one of [1] to [12], wherein the first guide is provided in the enclosure so as to be rotatable around an axis of rotation determined in advance with respect to the placement surface, and configured to rotate around the axis of rotation so as to be displaced between the first state and the second state, the axis of rotation intersects with the conveyance direction, the first quide includes one or more second protrusions protruding upward from the axis of rotation, and the one or more second protrusions are configured to guide the medium guided by the first quide in the second state toward a position downstream in the conveyance direction from the downstream end of the first guide in the conveyance direction above the placement section.
[14]

The image reading apparatus according to any one of [1] to [13], further including a discharge tray to which the medium after an image is read therefrom by the image reader is discharged, Wherein the discharge tray is located above the placement surface.
[15]

The image reading apparatus according to [14], wherein the discharge tray includes a first medium support and a second medium support different from the first medium support, the first medium support and the second medium support are disposed so as to be separate from each other in such a way that a distance between the first medium support and the second medium support in an intersecting direction is a predetermined distance, and the intersecting direction is a direction that intersects with the conveyance direction.
[16]

The image reading apparatus according to [15], wherein the enclosure includes an engaging section configured to engage with the first guide, the first guide includes an engaged section configured to engage with the engaging section, and is allowed to be pulled out of the enclosure in a predetermined pullout direction, the pullout direction is a direction parallel to the conveyance direction when viewed in the direction perpendicular to the placement surface, the engaging section includes a first engaging section with which the engaged section of the first guide in the first state engages, and a second engaging section with which the engaged section of the first guide in the second state engages, and the engaging section is located above the first medium support and the second medium support.
[17]

The image reading apparatus according to any one of [1] to [16], wherein when the first guide is in the first state, an upper surface of the first guide is contained in an imaginary plane containing an upper surface of the enclosure.

The embodiment of the present disclosure has been described in detail with reference to the drawings, but the specific configuration is not limited to that in the embodiment and may be changed, replaced, deleted, or otherwise modified without departing from the key points of the present disclosure.

What is claimed is:

1. An image reading apparatus attached to a printing apparatus and configured to read an image from a medium from which an image is to be read, the image reading apparatus comprising:
an enclosure;
a placement section having a placement surface at which the medium is placed;
a conveyer configured to convey the medium in a. predetermined conveyance direction;
a first quide that is displaceable between a first state and a second state, the first state being a state in which the first guide is located at a housed position determined in advance as a position where the first guide is housed in the enclosure above the placement section, the second state being a state in which the first guide is located at a supporting position determined in advance as a position where the first guide cooperates with the placement section to support the medium; and
an image reader configured to read an image from the medium conveyed by the conveyer,
wherein the conveyance direction is, when viewed in a direction perpendicular to the placement surface, parallel to a direction in which the printing apparatus conveys a print medium, and
the first quide in the second state inclines downward from upstream to downstream in the conveyance direction, and guides the medium conveyed by the conveyer to a position above an upstream end of the placement section in the conveyance direction or a position flush with the upstream end of the placement section in the conveyance direction.

2. The image reading apparatus according to claim 1, wherein
the first guide slides with respect to the placement section in parallel to the conveyance direction when viewed in the direction perpendicular to the placement surface so as to be displaceable between the first state and the second state.

3. The image reading apparatus according to claim 2, wherein
the enclosure includes an engaging section configured to engage with the first guide,
the first guide includes an engaged section configured to engage with the engaging section, and is allowed to be pulled out of the enclosure in a predetermined pullout direction,
the pullout direction is a direction parallel to the conveyance direction when viewed in the direction perpendicular to the placement surface, and
the engaging section includes a first engaging section with which the engaged section of the first guide in the first state engages, and a second engaging section with which the engaged section of the first quide in the second state engages.

4. The image reading apparatus according to claim 3, wherein
the first engaging section is located above the placement surface and extends in a direction parallel to the pullout direction, and
the second engaging section extends from an upstream end of the first engaging section in the conveyance direction toward a position below the first engaging section and downstream in the conveyance direction from the first engaging section.

5. The image reading apparatus according to claim 4, wherein
at least a portion of the second engaging section overlaps with the placement surface when viewed in the direction parallel to the pullout direction.

6. The image reading apparatus according to claim 3, wherein
the engaged section includes a first engaged section and a second engaged section arranged in parallel to the conveyance direction when the first guide is in the first state,
the first engaged section is located downstream in the conveyance direction from the second engaged section when viewed in the direction perpendicular to the placement surface,
the first engaging section is located above the placement surface and extends in a direction parallel to the pullout direction,
the second engaging section is an upstream end of the first engaging section in the conveyance direction and is configured to engage with the second engaged section of the first quide in the second state,
the engaging section includes a third engaging section configured to engage with the first engaged section when the second engaging section engages with the second engaged section, and
the third engaging section is located below the second engaging section and downstream in the conveyance direction from the second engaging section.

7. The image reading apparatus according to claim 6, wherein
a distance in the conveyance direction between a downstream end of the engaged section in the conveyance direction and a downstream end of the first guide in the conveyance direction is greater than or equal to a distance in the conveyance direction between a downstream end of the second engaging section in the conveyance direction and the upstream end of the placement section in the conveyance direction.

8. The image reading apparatus according to claim 1, wherein
the first guide includes a protrusion located downstream in the conveyance direction from a center of the first quide and protruding upward from the first guide, and
the protrusion is configured to guide the medium conveyed by the conveyer to the position above the upstream end of the placement section in the conveyance direction or the position flush with the upstream end of the placement section in the conveyance direction.

9. The image reading apparatus according to claim 1, wherein
a second guide configured to guide the medium is provided above the placement section and at a downstream end of the first guide in the conveyance direction, and
the second guide is configured to guide the medium guided by the first guide in the second state toward a position downstream in the conveyance direction from the downstream end of the first guide in the conveyance direction.

10. The image reading apparatus according to claim 9, wherein
at least a portion of the second guide is located on an upper surface of the enclosure when the first guide is in the first state, and is located on the placement surface when the first quide is in the second state.

11. The image reading apparatus according to claim 1, wherein
the first quide includes a protrusion located downstream in the conveyance direction from a center of the first guide and protruding upward from the first guide,
the protrusion is configured to guide the medium conveyed by the conveyer to the position above the upstream end of the placement section in the conveyance direction or the position flush with the upstream end of the placement section in the conveyance direction,
a second guide configured to guide the medium is provided above the placement section and at a downstream end of the first guide in the conveyance direction,
the second guide is configured to guide the medium guided by the first guide in the second state toward a position downstream in the conveyance direction from the downstream end of the first guide in the conveyance direction, and
when the first guide is in the second state, an uppermost end of the protrusion is above an uppermost end of the second guide or flush with the uppermost end of the second guide.

12. The image reading apparatus according to claim 1, wherein
the first guide includes
a protrusion located downstream in the conveyance direction from a center of the first guide and protruding upward from the first guide, and
a third guide located downstream in the conveyance direction from the protrusion and extending in a direction in which the first guide extends,
the protrusion is configured to guide the medium conveyed by the conveyer to the position above the upstream end of the placement section in the conveyance direction or the position flush with the upstream end of the placement section in the conveyance direction, and
a downstream end of the third guide in the conveyance direction is above the upstream end of the placement section in the conveyance direction or flush with the upstream end of the placement section.

13. The image reading apparatus according to claim 1, wherein
the first quide is provided in the enclosure so as to be rotatable around an axis of rotation determined in advance with respect to the placement surface, and configured to rotate around the axis of rotation so as to be displaced between the first state and the second state,
the axis of rotation intersects with the conveyance direction,
the first guide includes one or more second protrusions protruding upward from the axis of rotation, and
the one or more second protrusions are configured to guide the medium guided by the first guide in the second state toward a position downstream in the conveyance direction from a downstream end of the first guide in the conveyance direction above the placement section.

14. The image reading apparatus according to claim 1, further comprising
a discharge tray to which the medium after an image is read therefrom by the image reader is discharged,
wherein the discharge tray is located above the placement surface.

15. The image reading apparatus according to claim 14, wherein
the discharge tray includes a first medium support and a second medium support different from the first medium support,
the first medium support and the second medium support are disposed so as to be separate from each other in such a way that a distance between the first medium support and the second medium support in an intersecting direction is a predetermined distance, and
the intersecting direction is a direction that intersects with the conveyance direction.

16. The image reading apparatus according to claim 15, wherein
the enclosure includes an engaging section configured to engage with the first guide,
the first guide includes an engaged section configured to engage with the engaging section, and is allowed to be pulled out of the enclosure in a predetermined pullout direction,
the pullout direction is a direction parallel the conveyance direction when viewed in the direction perpendicular to the placement surface,
the engaging section includes a first engaging section with which the engaged section of the first quide in the first state engages, and a second engaging section with which the engaged section of the first guide in the second state engages, and
the engaging section located above the first medium support and the second medium support.

17. The image reading apparatus according to claim 1, wherein
when the first guide is in the first state, an upper surface of the first guide is contained in an imaginary plane containing an upper surface of the enclosure.
